(19) United States
(12) Patent Application Publication
(10) Pub. No.: US 2008/0002849 A1
(43) Pub. Date: Jan. 3, 2008

(54) Modular behind-the-ear hearing aid

(75) Inventor: Beng Hai Tan, Singapore (SG)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISSCHE TECHNIK GmbH

(21) Appl. No.: 11/823,729

(22) Filed: Jun. 28, 2007

(30) Foreign Application Priority Data
Jun. 29, 2006 (DE) 10 2006 029 958.2

(51) Int. Cl. H04R 25/00

(52) U.S. Cl. 381/330; 381/322

(57) ABSTRACT

The invention relates to a modular behind-the-ear hearing aid (BTE) with a variably small size. The BTE can be designed for different performance levels and a different range of functions for manufacturing and maintaining the BTE easily and cheaply. The modular behind-the-ear hearing aid can be assembled from two units, wherein the first unit is a base unit which provides the behind-the-ear hearing aid with a basic range of functions of a particular series of the behind-the-ear hearing aid, and the second unit is a plug-in unit which can be plugged into the base unit and which provides the behind-the-ear hearing aid with an additional range of functions in accordance with customers' wishes, wherein the basic range of functions of the base unit only forms an operational behind-the-ear hearing aid in conjunction with the additional range of functions of the plug-in unit.

### CROSS REFERENCE TO RELATED APPLICATIONS

This application claims priority of German application No. 10 2006 029 958.2 filed Jun. 29, 2006, which is incorporated by reference herein in its entirety.

### FIELD OF THE INVENTION

The invention relates to a modular behind-the-ear hearing aid.

### BACKGROUND OF THE INVENTION

The adaptation of hearing aids to different types of hearing impairment by means of different performance levels and the demand for ever smaller hearing aids is forcing hearing aid manufacturers to come up with a wide range of hearing aids of different sizes for different performance levels. This is resulting in particular in a modular structure for a hearing aid. Modular hearing aids are known in which the modules are situated inside the hearing aid and are surrounded by a casing.

EP 0 337 195 A2 discloses a hearing aid, in particular a behind-the-ear hearing aid, made up of four casing modules, each of which can be preinstalled individually. Each module here is designed for a respective required performance level of the hearing aid, as a result of which series of hearing aids can be implemented which are suitable for different requirements. The hearing aid here has a microphone module, an earpiece module, an amplifier module and a power supply module, which when assembled together form the hearing aid.

WO 00/79834 A1 discloses a behind-the-ear hearing aid and a plug-in module therefor. This means that the range of functions of the fully operational hearing aid can be upgraded by means of the plug-in module. To this end, a connector of the plug-in module is plugged into a battery compartment of the hearing aid and is thereby connected electrically and mechanically to the behind-the-ear hearing aid. In this hearing aid upgraded with the plug-in module the battery is situated in the plug-in module. The plug-in module provides, for example, an interface for wireless signal transmission, a programming unit, a further audio input, a larger battery compartment and/or a mechanical control unit.

A disadvantage of such hearing aids in accordance with the prior art is that nothing can be done to influence their size. In other words, their size cannot be adapted to a different level of hearing impairment, and hence people with only a slight hearing impairment nevertheless have to wear a comparatively large hearing aid.

### SUMMARY OF THE INVENTION

The object of the invention is to create a behind-the-ear hearing aid—referred to in the following as a BTE—which can be designed for different performance levels and a different range of functions in combination with a variably small size. The BTE should here be easy and cost-effective to manufacture and maintain, it additionally being possible to adapt the BTE subsequently, when used as a hearing aid, to increased requirements on the part of the wearer or to newly developed technical possibilities.

The object of the invention is achieved by a modular BTE consisting of just two mutually separable units—a base unit and a plug-in unit which can be provided on the base unit, with just these two units together forming an operational BTE. The base unit here preferably provides a basic range of functions for a particular series of the BTE. The plug-in unit accordingly provides, for example, an additional range of functions in accordance with customers' wishes or needs and/or a level of hearing impairment to be treated.

The combination of interchangeable plug-in units with the same base unit means that BTEs in a series can be manufactured on an automated basis, it being possible for the BTEs to have a different range of functions and at the same time to satisfy the aesthetic needs of wearers. According to the invention it is possible to implement a BTE of minimal size for a particular hearing impairment with a particular range of functions. Compared to the prior art, fewer tools are needed during manufacture for the same range of functions of the BTE series, which cuts the cost of tools and hence of manufacturing.

According to the invention the base unit for all devices in a BTE series contains a basic, identical range of functions, while the BTE contains an additional variable range of functions thanks to the plug-in unit which can be plugged in to the base unit. This variable range of functions relates to, for example, an amplifier, a maximum service life of the BTE with an energy store, quality of signal processing, a volume control, an upgrade to bidirectional reception for the BTE and/or a program selection switch. Furthermore, a telecoil is preferably accommodated in the plug-in unit.

The plug-in unit is used in particular to upgrade the BTE by means of a second microphone. As a result, a correspondingly installed signal processor—likewise preferably accommodated in the plug-in unit—can easily distinguish e.g. wind noise in a wide, low-contrast spectrum from music containing peaks in the frequency spectrum, or from the human voice on the basis of its dynamic range. The signal processor also selects a corresponding hearing program for the wearer of the BTE and correspondingly controls the earpiece of the BTE.

Furthermore, the battery or accumulator of the BTE is preferably accommodated in the plug-in unit, since this varies in size depending on the capacity and requires a comparatively large amount of space within the BTE. From the customer's perspective it is not advantageous to wear a comparatively large BTE, which because of a minor hearing impairment on the part of the wearer has only a low amplification performance at the same time as a long service life with just one battery. Preferably the BTE is smaller and the service life with just a single battery is limited. Thus because for cosmetic reasons the BTE should be as small as possible, it is possible in accordance with the invention to use as small a battery as possible, e.g. for brief use of the BTE or in the case of a slight hearing impairment, so that as little space as possible is needed with the inventive plug-in unit. In other words, a minimum space for a particular hearing aid application can be found.

Furthermore, the amplifier and a corresponding signal processor are preferably situated in the plug-in unit of the BTE, and in turn are adjusted to the range of functions and a maximum acoustic amplification of the BTE, so that as a result the plug-in unit can be designed to be as small as possible, depending on the degree of hearing impairment and corresponding customer requirements.

According to the invention, the base unit mainly contains the acoustic components of the BTE, with an earpiece and a connector for a support hook with an acoustic tube.

Furthermore, the base unit preferably contains at least an ambient microphone. Thanks to an additional ambient microphone in the plug-in unit, directional reception of the BTE can be implemented with the plug-in microphone. In contrast to the prior art, the single ambient microphone already present is not replaced by a pair of microphones, but the existing ambient microphone is supplemented by the second microphone in the plug-in unit, which together form the pair of microphones for directional reception.

By dividing the range of functions of a BTE into functions which are common to all devices in a series, and into functions which can be adjusted to customers' needs, and by a corresponding assignment of these functions to a base unit and a plug-in unit, it is now possible for each customer to implement the smallest BTE for him or her and nevertheless to guarantee efficient manufacture and maintenance of the BTE.

The inventive BTE opens up a multitude of possibilities, particularly as regards the design and color-scheme. In a preferred embodiment of the invention the plug-in unit fits snugly into the base unit; these are continuously in contact over the whole surface and together form a unit with a uniform appearance. It is of course possible for the plug-in unit to be in a contrasting color.

The plug-in unit is electrically and mechanically connected to the base unit. An electrical connection occurs e.g. via electrical wires and/or an electrical connection system, for example plug-in or spring contacts. A mechanical connection can be effected e.g. by screwing, latching, snap-locking or what is known as a “slide and lock” mechanism.

Furthermore, it is possible according to the invention to use, for each base unit, a plurality of plug-in units for a single wearer, which for their part are adapted to different circumstances. Thus by using a plug-in unit it is possible to implement as small as possible a BTE when the latter is worn in public, whereas for private purposes a larger plug-in unit with a longer battery service life is more expedient. Also conceivable, for example, are different plug-in units for night-time (many hearing aid wearers wear this even while they are asleep), sport, attending a concert, etc. Plug-in units ergonomically adjusted to habits and circumstances are expedient especially for night-time and for sport.

Furthermore, the invention relates to a modular BTE with an attached support hook, as well as a modular BTE with a support hook and an otoplastic provided thereon.

Other preferred embodiments of the inventive BTE emerge from the additional dependent claims.

### BRIEF DESCRIPTION OF THE DRAWINGS

The invention is explained in greater detail in the following on the basis of exemplary embodiments, with reference to the drawing. The drawing shows:

FIG. 1 a side view of a base unit of an inventive modular behind-the-ear hearing aid (BTE);

FIG. 2 the base unit from FIG. 1 with a support hook provided thereon;

FIG. 3 a side view of a second embodiment of an inventive plug-in unit;

FIG. 4 a side view of a third embodiment of the inventive plug-in unit;

FIG. 5 a full BTE according to a first embodiment of the invention with a support hook connected thereto;

FIG. 6 a BTE according to a second embodiment of the invention; and

FIG. 7 a BTE according to a third embodiment of the invention.

### DETAILED DESCRIPTION OF THE INVENTION

In the following a BTE (behind-the-ear hearing aid) is understood to be a base unit with a plug-in unit non-detachably connected thereto. In other words, the BTE does not have a support hook, an acoustic tube or an otoplastic. Furthermore, the inventive BTE should not be restricted to the exemplary embodiments shown in the drawing, but very generally relate to a two-part BTE, the first component of which provides a basic range of functions for a particular series of BTEs, and the second component of which provides an additional range of functions in accordance with customers' requirements, with only the common range of functions of the two components providing an independently operational BTE.

The demands on a BTE are numerous and in part contradictory, so that a good compromise between function range/performance range and the size of the BTE must always be found. The demands on a BTE are especially conflicting as regards the cosmetic aspect of miniaturization and an average service life of the BTE with a single energy store.

Furthermore, there are a multitude of different degrees of hearing impairment to which the BTE has to be adjusted. Thus for example for a slight hearing impairment a smaller acoustic amplification is necessary than for a major hearing impairment, which impacts considerably for example on the power supply and the amplification and thus also on the size of the BTE. In the case of a major hearing impairment, for example, the service life of the BTE drops compared to a slight hearing impairment with the same battery capacity. To achieve this same service life, it is thus necessary to use a larger battery, i.e. simultaneously also a larger BTE. These demands also affect the earpiece (loudspeaker), which depending on the degree of hearing impairment has to emit more or less acoustic energy, which impacts on the size and design.

In addition it is necessary to be able to provide different support hooks on the BTE, in order to be able to provide as many customers as possible with a BTE. In other words, it should be possible for children, as well as for men and women with and without glasses, to wear the BTE. Furthermore, operating elements such as a volume control, a program selection switch and an on/off switch are required. The question also arises of whether the BTE with just one microphone should include omnidirectional reception or the BTE with two or more microphones should include directional reception and a corresponding further processing of the signals, and how the amplifier and the processor unit used are configured and what range of functions they should possess.

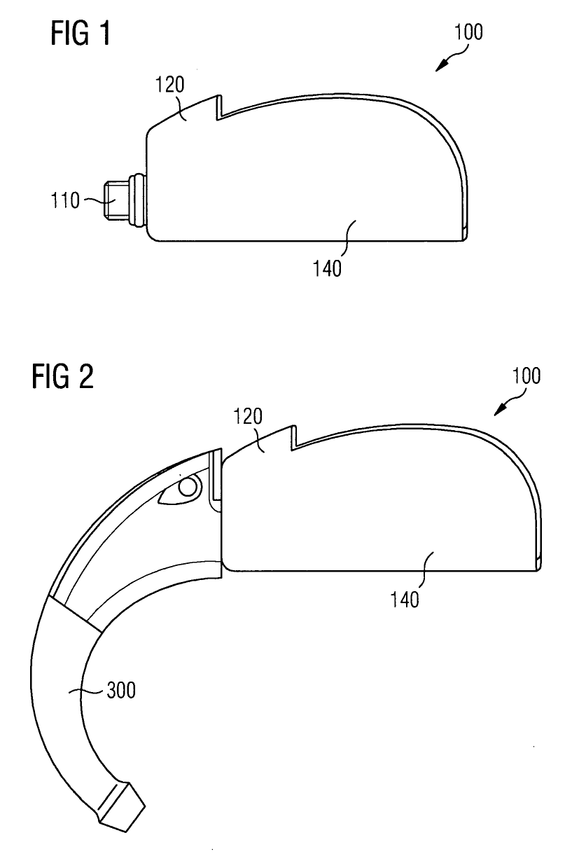

FIG. 1 now shows an inventive base unit 100 of an inventive BTE 1 (see FIG. 5 to 7), the base unit 100 essentially consisting of a base element 140 and a shoulder 120 formed thereon. The base unit 100 provides the BTE 1 with a basic range of functions for e.g. a particular series of BTEs. For this the base unit 100 has at least an earpiece (not shown in the drawing) and a connector 110 for a support hook 300 (see FIG. 2). Furthermore, the base unit 100 preferably also has an ambient microphone (not shown in the drawing).

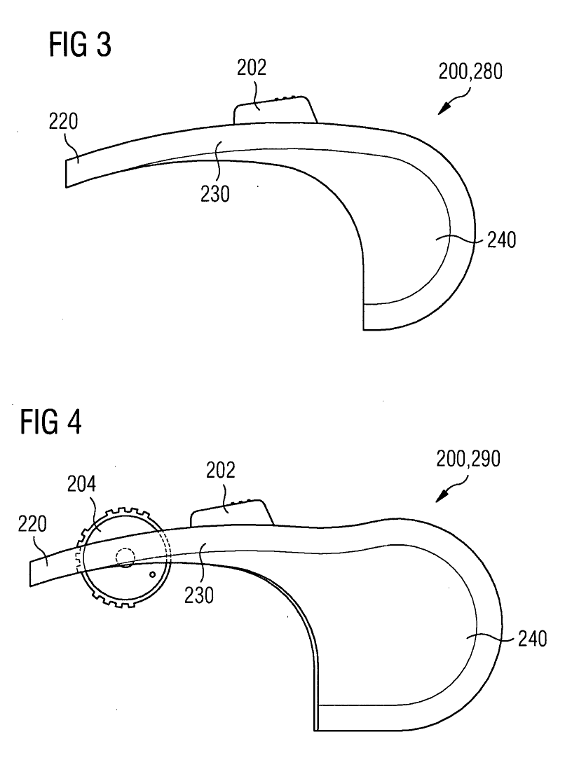

Depending on the flexibility and range of functions of the inventive BTE 1 a base unit 100 can preferably have one or more of the following components (not shown in the drawing): an auditory canal microphone, an on/off switch, a program selection switch, a battery or accumulator and/or a volume control. In addition it is also possible to partially integrate functions into the base unit 100 which in fact are reserved to an inventive plug-in unit 200 (see FIGS. 3 and 4), in order thus to make available a BTE 1 with less flexibility as regards customers' wishes but which nonetheless offers the benefit of a lower-cost BTE 1. As regards the corresponding functions, see the parallel paragraph for the plug-in unit 200.

FIG. 5 shows a first 270 (but connected to a base unit 100) and FIG. 3 and 4 a second 280 and a third 290 embodiment of the inventive plug-in unit 200. A general form of the plug-in unit 200 has a plug-in element 240, a transition section 230 extending away therefrom and an adjoin piece 220 provided on the free end of the transition section 230. The plug-in element 240, the transition section 230 and the adjoin piece 220 merge continuously into one another and in the assembled state of the plug-in unit 200 with the base unit 100 form the BTE (see FIG. 5 to 7).

The plug-in unit 200; 270, 280, 290 includes an additional range of functions for the BTE 1 in accordance with customers' wishes and needs. Preferably the plug-in unit 200; 270, 280, 290 has a second ambient microphone for the BTE 1, a battery or an accumulator and/or an amplifier. Furthermore, the plug-in unit 200 can include one or more of the following components: a signal processing unit, a telecoil, a volume control, an on/off switch, an auditory canal microphone and/or a program selection switch.

In particular the plug-in unit 200 contains and fixes in position the amplifier or the amplifier circuit located on a PCB, in order to adjust the BTE 1 depending on the nature and degree of a customer's hearing impairment. The plug-in unit 200 preferably has openings for the volume control and/or the program selection switch, which in this case can be provided on the base unit 100 (regulators and/or switches of such a BTE 1 project through the plug-in unit 200 in the assembled state of the two units 100, 200) or on the plug-in unit 200. Preferably the plug-in unit 200 has a second ambient microphone which together with a first ambient microphone—which is preferably located in the base unit 100, but can also be located in the plug-in unit 200—make directional reception possible for the BTE 1 and thus enable directional hearing for the wearer of the BTE 1.

The second embodiment shown in FIG. 3 of the inventive plug-in unit 280 is fitted with a program selection switch 202, in order to make different bearing programs available to the BTE 1. This is implemented by a corresponding signal processing unit and the amplifier inside the plug-in unit 280.

FIG. 4 shows the third embodiment of the inventive plug-in unit 290, supplemented by a volume control 204 in contrast to the second embodiment. The third embodiment hereby makes available an extended range of functions, as a result of which it is possible to set a volume of the BTE 1 manually.

In preferred embodiments of the invention the plug-in unit 200 contains an energy store which supplies the BTE 1 with electrical power. Especially as a result of this it is possible to design the size of the BTE 1 with a single energy store on the basis of its service life. If a long service life is required, a correspondingly large battery and a correspondingly large plug-in unit 200 are selected; if a long service life is forgone or if the wearer's corresponding hearing impairment is only slight, the plug-in unit 200 can be selected to be smaller, since a correspondingly smaller battery or accumulator can be used. In this case the battery or accumulator is situated in the plug-in element 240 of the plug-in unit 200. The same applies for the amplifier, which depending on the degree of hearing impairment can be designed differently. In addition, different demands are placed on a signal processing unit of a BTE 1, which must process the information from two or more microphones, than on a BTE 1 with just one ambient microphone. This range of functions is hence preferably implemented by the plug-in unit 200.

FIG. 5 shows the first basic embodiment of the inventive plug-in unit 270 in the assembled state on a base unit 100. A volume control and a program selection switch can be provided in concealed form with such an embodiment.

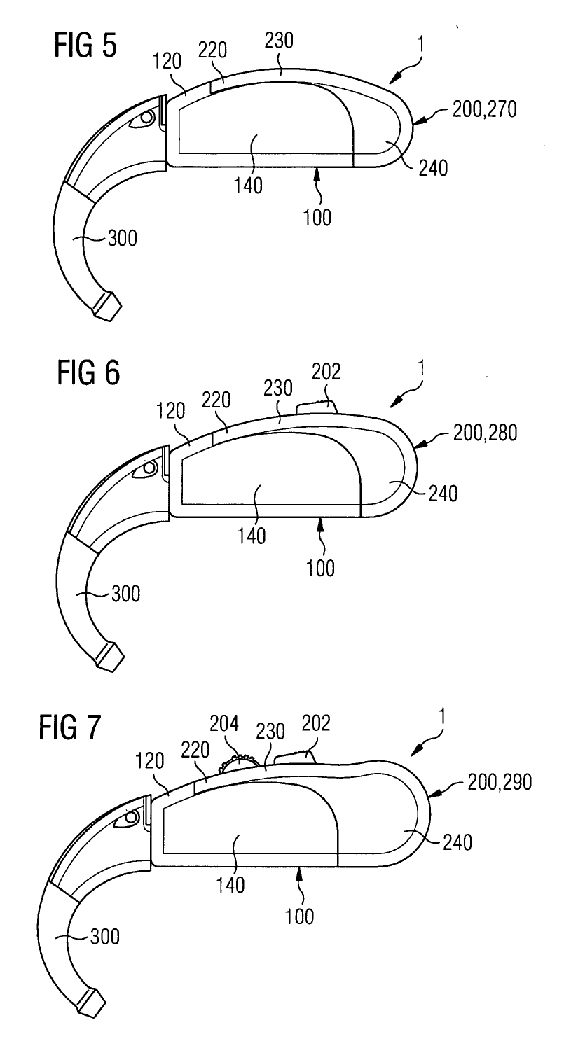

FIG. 6 and 7 respectively show the second 280 and third 290 embodiment of the inventive plug-in unit 200, likewise in the assembled state of the BTEs 1. In particular the third embodiment of the inventive plug-in unit 290 has a larger battery compared to the other two embodiments.

With the inventive BTE 1 the plug-in unit 200 and base unit 100 can be configured such that the battery or accumulator partially projects from the plug-in unit 200, as a result of which the section of the projecting battery/accumulator is housed in a corresponding compartment in the base unit 100 in the assembled BTE 1. This could be the case for example in embodiments according to FIG. 5 and FIG. 6. Furthermore, it is preferable that a battery charger of the BTE 1 is held in its closed position by plugging the plug-in unit 200 in to the base unit 100.

In all embodiments of the invention, the plug-in unit 200 closely abuts the base unit 100 and together they produce a compact uniform external appearance. In particular the adjoin piece 220 of the plug-in unit 200 rests on the shoulder 120 of the base unit 100 and together they form a common surface which has a continuous transition. Furthermore, the transition section 230 and the plug-in element 240 lie on the base element 140 of the base unit 100.

1.-13. (canceled)

14. A behind-the-ear hearing aid, comprising:
a base unit that provides a basic range of functions of the behind-the-ear hearing aid; and
a plug-in unit that can be plugged into the base unit and provides an additional range of functions of the behind-the-ear hearing aid according to a requirement of a user of the behind-the-ear hearing aid,
wherein the behind-the-ear hearing aid is configured to be operated based on the basic range of functions in conjunction with the additional range of functions, and
wherein a size of the base unit and a size of the plug-in unit can be varied for a different basic range of functions and a different additional range of functions so that a size of the behind-the-ear hearing aid can be varied accordingly.

15. The behind-the-ear hearing aid as claimed in claim 14, wherein the base unit comprises a component selected from the group consisting of: an earpiece, a connector with an acoustic tube for connecting to a support hook of the behind-the-ear hearing aid, an ambient microphone, an auditory canal microphone, an on/off switch, a program selection switch, a battery or an accumulator, and a volume control.

16. The behind-the-ear hearing aid as claimed in claim 14, wherein the plug-in unit comprises a component selected from the group consisting of: an ambient microphone, a battery or an accumulator, an amplifier, a signal processing unit, a telecoil, a volume control, an on/off switch, and a program selection switch.

17. The behind-the-ear hearing aid as claimed in claim 14, wherein the plug-in unit holds a battery charger and the charger is in a closed position when the plug-in unit sits on the base unit.

18. The behind-the-ear hearing aid as claimed in claim 14, wherein the base unit comprises a base element and a shoulder.

19. The behind-the-ear hearing aid as claimed in claim 18, wherein the plug-in unit sits on the shoulder of the base unit.

20. The behind-the-ear hearing aid as claimed in claim 19, wherein the plug-in unit comprises a plug-in element, a transition section extending away from the plug-in element, and an adjoin piece on a free end of the transition section.

21. The behind-the-ear hearing aid as claimed in claim 20, wherein the plug-in element, the transition section, and the adjoin piece merge continuously into each other.

22. The behind-the-ear hearing aid as claimed in claim 20, wherein a surface of the adjoin piece is continuously shaped with a surface of the shoulder.

23. The behind-the-ear hearing aid as claimed in claim 20, wherein a battery or an accumulator compartment is provided in the plug-in element.

24. The behind-the-ear hearing aid as claimed in claim 14, wherein the base unit is electrically connected with the plug-in unit via electrical plug-in or a spring contact.

25. The behind-the-ear hearing aid as claimed in claim 14, wherein the base unit is mechanically connected with the plug-in unit by snapping or pushing the plug-in unit into the base unit and latching to the base unit.

26. The behind-the-ear hearing aid as claimed in claim 14, wherein a support hook of the behind-the-ear hearing aid is connected to the base unit via an integrated acoustic tube and an otoplastic is connected to the support hook.

27. The behind-the-ear hearing aid as claimed in claim 14, wherein the behind-the-ear hearing aid is a modular behind-the-ear hearing aid.

28. The behind-the-ear hearing aid as claimed in claim 14, wherein the size of the base unit and the size of the plug-in unit can be varied for different performance levels of the behind-the-ear hearing aid.

29. A hearing aid, comprising:
a base unit that provides a basic range of functions of the hearing aid; and
a plug-in unit that can be plugged into the base unit and provides an additional range of functions of the hearing aid according to a requirement of a user of the hearing aid.

30. The hearing aid as claimed in claim 29, wherein the hearing aid is operated based on the basic range of functions in conjunction with the additional range of functions.

31. The hearing aid as claimed in claim 29, wherein a size of the base unit and a size of the plug-in unit can be varied for a different basic range of functions and a different additional range of functions or different performance levels of the hearing aid so that a size of the hearing aid can be varied accordingly.

32. A method for manufacturing a hearing aid, comprising:
providing a base unit according to a basic range of functions of the hearing aid; and
providing a plug-in unit according to an additional range of functions of the hearing aid from a requirement of a user of the hearing aid; and
plugging the plug-in unit into the base unit for operating the hearing aid based on the basic range of functions in conjunction with the additional range of functions.

33. The method as claimed in the claim 32, wherein a size of the base unit and a size of the plug-in unit can be varied for a different basic range of functions and a different additional range of functions or different performance levels of the hearing aid so that a size of the hearing aid can be varied accordingly.
